(19) United States
(12) Patent Application Publication
(10) Pub. No.: US 2022/0126420 A1
(43) Pub. Date: Apr. 28, 2022

(54) SUPERHARD MATERIAL ABRASIVE BELT FOR GRINDING AND POLISHING AND PREPARATION METHOD AND USE THEREOF

(71) Applicant: Zhengzhou Ruite Diamond Belts Co., Ltd, Zhengzhou (CN)

(72) Inventors: Yijin AN, Zhengzhou (CN); Jianmin AN, Zhengzhou (CN); Chunxu YANG, Zhengzhou (CN)

(73) Assignee: Zhengzhou Ruite Diamond Belts Co., Ltd, Zhengzhou (CN)

(21) Appl. No.: 17/474,108

(22) Filed: Sep. 14, 2021

(30) Foreign Application Priority Data
Oct. 22, 2020 (CN) 202011138794.X

(51) Int. Cl. B24D 11/00; C09G 1/02; C09K 3/14

(52) U.S. Cl. CPC B24D 11/001; C09K 3/1409; C09G 1/02

(57) ABSTRACT

A superhard material abrasive belt for grinding and polishing and a preparation method and use thereof are disclosed. The superhard material abrasive belt includes a lining cloth layer, an electroplating substrate, which is above the lining cloth layer, a grinding unit, which is on the electroplating substrate, a binder layer, which is between the electroplating substrate and the lining cloth layer, and a modified resin layer, which is arranged in the gap between the grinding units on the electroplating substrate.

### CROSS REFERENCE TO RELATED APPLICATIONS

This patent application claims the benefit and priority of Chinese Patent Application No. 202011138794.X, filed on Oct. 22, 2020, the disclosure of which is incorporated by reference herein in its entirety for all purposes.

### TECHNICAL FIELD

The present disclosure relates to the technical field of superhard material abrasive belts, and in particular relates to a superhard material abrasive belt for grinding and polishing and a preparation method and use thereof.

### BACKGROUND

The existing diamond abrasive belts are generally provided with particular gaps for chips removal. Therefore, when used to grind high-hardness materials such as stone, titanium alloy, and superalloy, small scratches are left on the surface of the workpiece to be processed due to the presence of the gaps for chips removal, thus adversely affecting the appearance quality of the entire workpiece.

### SUMMARY

An object of the present disclosure is to provide a superhard material abrasive belt for grinding and polishing, which achieves polishing effects while grinding, makes it possible to have a significantly improved microscratch effect on the surface of materials (which have a relatively high requirement on the surface, such as stone and titanium alloy, and superalloy), and has a good grinding and polishing effect without additional process(es); also with a preparation method and use thereof.

In order to achieve the above object, the present disclosure provides the following technical solutions:

The present disclosure provides a superhard material abrasive belt for grinding and polishing, comprising:

a lining cloth layer;

an electroplating substrate, which is above the lining cloth layer;

a grinding unit, which is on the electroplating substrate; and

a binder layer, which is between the electroplating substrate and the lining cloth layer,

wherein, further comprising a modified resin layer, which is arranged in the gap between the grinding units on the electroplating substrate.

In some embodiments, the modified resin layer is a polyurethane binder layer.

In some embodiments, the grinding unit comprises a diamond abrasive unit and a cubic boron nitride (CBN) abrasive unit, and the grinding units are arranged in an orderly manner.

In some embodiments, both of the diamond abrasive unit and the CBN abrasive unit have a particle size of 400-5000 mesh.

The present disclosure also discloses a process for preparing the superhard material abrasive belt for grinding and polishing, comprising steps of:

(1) preparing a polyurethane binder: adding polyurethane to cerium oxide at ambient temperature, mixing with an electric stirrer to be uniform, adding a curing agent, stirring to be uniform, to obtain the polyurethane binder, wherein a mass ratio of polyurethane, the curing agent, and cerium oxide is 100:15:30;

(2) feeding the polyurethane binder obtained in step (1) into a spreader, blade coating the polyurethane binder into the gap between the grinding units arranged in an orderly manner on a first electroplating abrasive belt, wherein the first electroplating abrasive belt comprises a lining cloth layer; an electroplating substrate, which is above the lining cloth layer, a grinding unit, which is on the electroplating substrate, and a binder layer, which is between the electroplating substrate and the lining cloth layer. Due to the height of the grinding units is consistent and the gap is uniform, so the polyurethane filling is also uniform;

(3) covering the polyurethane binder coated in step (2) with a layer of anti-sticking cloth, putting into a platen press and heating to 80° C., and maintaining at 80° C. for 1 hour, then taking out to obtain the superhard material abrasive belt for grinding and polishing.

The present disclosure also discloses use of the superhard material abrasive belt for grinding and polishing as described above, for fine and ultra-fine grinding and polishing a difficult-to-grind material such as stone, titanium alloy and superalloy.

Some advantages of technical solutions according to the present disclosure are as follows:

1. the coexistence of the mixed abrasive and the polyurethane binder layer makes contribution to significant improvement of microscratch effects on the surface of materials (which have a relatively high requirement on the surface, such as stone and titanium alloy, and superalloy), and achievement of a good effect of grinding and polishing without additional process(es), which greatly reduces the processing procedures and is cost-effective;

2. due to the mixed abrasive is composed of diamond abrasive and CBN abrasive, the processing efficiency of the workpiece to be processed which is made of a hard-to-grind material, is greatly improved;

3. according to the present disclosure, the superhard material abrasive belt also significantly reduces the pollution to the environment during the processing, and also reduces the discharge of solid waste and liquid waste.

### BRIEF DESCRIPTION OF THE FIGURES

FIGS. 1A and 1B show structure schematic diagrams of superhard material abrasive belts with and without a polyurethane binder layer, respectively.

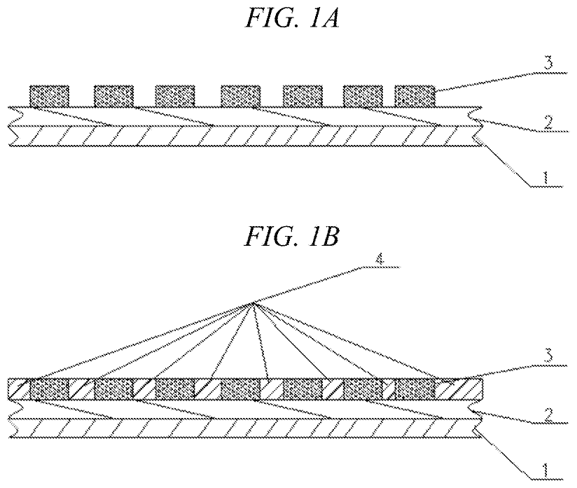

In FIGS. 1A and 1B, 1 represents a lining cloth layer, 2 represents an electroplating substrate, 3 represents a grinding unit, and 4 represents a modified resin layer.

In the FIGURE, 1 represents a lining cloth layer, 2 represents an electroplating substrate, 3 represents a grinding unit, and 4 represents a modified resin layer.

### DETAILED DESCRIPTION OF THE EMBODIMENTS

As shown in FIGS. 1A and 1B, a superhard material abrasive belt for grinding and polishing comprises a lining cloth layer; an electroplating substrate, which is above the lining cloth layer; a grinding unit, which is arranged on the electroplating substrate, and consists of a diamond abrasive grinding unit and a CBN abrasive grinding unit, wherein the diamond abrasive grinding unit and the CBN abrasive grinding unit are arranged in an orderly way, and have a size of 400-5000 mesh; a binder layer, which is between the electroplating substrate and the lining cloth layer; and a modified resin layer, which is provide in the gap between the grinding units on the electroplating substrate, wherein the modified resin layer is a polyurethane binder layer.

A process for preparing the superhard material abrasive belt for grinding and polishing is provided. In some embodiments, the process was performed according to the following procedure:

(1) Preparation of a polyurethane binder: polyurethane was added to cerium oxide at ambient temperature, and they were mixed with a electric stirrer to be uniform; a curing agent was added and the resulting mixture was stirred to be uniform, obtaining the polyurethane binder, wherein the dosage ratio of polyurethane, the curing agent, and cerium oxide was 100:15:30.

(2) The polyurethane binder obtained in step (1) was added into a spreader, and the polyurethane binder was blade coated into the gap between the grinding units arranged in an orderly manner on a first electroplating abrasive belt, wherein the first electroplating abrasive belt comprises a lining cloth layer; an electroplating substrate, which is above the lining cloth layer, a grinding unit, which is on the electroplating substrate, and a binder layer, which is between the electroplating substrate and the lining cloth layer; because the heights of the grinding units were the same, and the gaps were uniform, the fillings of polyurethane were also uniform.

(3) The polyurethane binder coated in step (2) was covered with a layer of anti-sticking cloth, put into a platen press and heated to 80° C., maintained at 80° C. for 1 hour, and then it was taken out of the platen press, obtaining the superhard material abrasive belt for grinding and polishing.

Use of the superhard material abrasive belt for grinding and polishing, for fine and ultra-fine grinding and polishing a difficult-to-grind material such as stone, titanium alloy and superalloy is provided.

What is claimed is:

1. A superhard material abrasive belt for grinding and polishing, comprising:
a lining cloth layer;
an electroplating substrate, which is above the lining cloth layer;
a grinding unit, which is on the electroplating substrate;
a binder layer, which is between the electroplating substrate and the lining cloth layer; and
a modified resin layer, which is arranged in the gap between grinding units on the electroplating substrate.

2. The superhard material abrasive belt for grinding and polishing as claimed in claim 1, wherein the modified resin layer is a polyurethane binder layer.

3. The superhard material abrasive belt for grinding and polishing as claimed in claim 2, wherein the grinding unit comprises a diamond abrasive unit and a CBN abrasive unit, and the grinding units are arranged in an orderly manner.

4. The superhard material abrasive belt for grinding and polishing as claimed in claim 3, wherein both of the diamond abrasive unit and the CBN abrasive unit have a particle size of 400-5000 mesh.

5. A process for preparing the superhard material abrasive belt for grinding and polishing as claimed in claim 1, comprising:
(1) preparing a polyurethane binder: adding polyurethane to cerium oxide at ambient temperature, mixing with a electric stirrer to be uniform, adding a curing agent and stirring to be uniform, to obtain the polyurethane binder, wherein the dosage ratio of polyurethane, the curing agent, and cerium oxide is 100:15:30;
(2) feeding the polyurethane binder obtained in step (1) into a spreader, blade coating the polyurethane binder into the gap between the grinding units arranged in an orderly manner on a first electroplating abrasive belt, wherein the first electroplating abrasive belt comprises:
a lining cloth layer;
an electroplating substrate, which is above the lining cloth layer;
a grinding unit, which is on the electroplating substrate; and
a binder layer, which is between the electroplating substrate and the lining cloth layer; and
(3) covering the polyurethane binder coated in step (2) with a layer of anti-sticking cloth, putting into a platen press and heating to 80° C., maintaining at 80° C. for 1 hour, and taking out, to obtain the superhard material abrasive belt for grinding and polishing.

6. A method for fine and ultra-fine grinding and polishing a difficult-to-grind material, comprising:
using the superhard material abrasive belt for grinding and polishing as claimed in claim 1.
